(19) United States
(12) Patent Application Publication
(10) Pub. No.: US 2015/0010813 A1
(43) Pub. Date: Jan. 8, 2015

(54) CURVED BATTERY AND MANUFACTURING METHOD THEREOF

(71) Applicant: Power Source Energy Co., Ltd., Taipei City (TW)

(72) Inventors: Chen-Heng Ko, Taipei City (TW); Chao-Tsan Huang, Taipei City (TW); Guiping Zhang, Taipei City (TW)

(21) Appl. No.: 14/322,914

(22) Filed: Jul. 3, 2014

(30) Foreign Application Priority Data
Jul. 5, 2013 (TW) 102212788

(51) Int. Cl. H01M 10/04; H01M 10/02

(52) U.S. Cl. CPC H01M 10/04; H01M 10/02
USPC 429/211; 429/122; 29/623.5

(57) ABSTRACT

A curved battery and manufacturing method thereof, includes the following steps: electroplating an electrode sheet, rolling said electrode sheet along its long side, first sealing, heating, pouring in electrolyte fluid, charging, vacuuming, second sealing, and shaping. Wherein, the electrode sheet is of a long strip shape, with its outside wrapped with separation film, to separate the positive electrode and negative electrode. While perform rolling, it is performed along its long side, to remove the stress that may occur after the product is produced. Then, sealing is performed by using films made of water resistant and heat resistant material for sealing at least three side edges. Pour in electrolyte fluid of LiPF₆ in an overall temperature of 75 degrees. Afterwards, charging the electrolyte fluid, perform vacuuming, and perform second sealing. Finally, using heated tools to bend the half-finished battery into shape, to form a curved battery having uniform curvature.

### BACKGROUND OF THE INVENTION

1. Field of the Invention

The present invention relates to a curved battery, and in particular to a curved battery and a manufacturing method thereof, such that the battery main body has a uniform curvature as a whole.

2. The Prior Arts

Presently, in general, the lithium battery is of a rhomboid or cylindrical shape having a planar surface of 180 (or 0) degrees along its longitude axis. In order to fit in and accommodate this type of battery, usually a 3C product utilized in our daily life is provided with space therein to receive the rhomboid or cylindrical shape battery.

The problem brought by this type of battery is that, a designer is not able to make significant changes to the shape of the existing product, due to the volume and size of the battery. Presently, another type of lithium battery available on the market has a curved surface of an angle less than 90 degrees along its longitudinal axis. This type of battery can be used in products, such as watches as power supply.

With the present trend of decreasing size of electronic products, the size of space in electronic products for receiving battery is getting smaller. Further, due to structure design considerations, the space for receiving battery can be of an irregular shape.

Due to the diminishing size of electronic products, the shape of the existing battery has to be changed significantly to fit for the reduced space for receiving battery of the electronic products. However, as mentioned earlier, the existing batteries are of fixed shapes and sizes, that can not be fitted into the irregular shape space (such as arc shape) for the battery. Therefore, the development of the electronic products is not able to achieve meaningful breakthrough due to the limitation of battery size and shape.

In order to solve the limitation of the electronic products caused by the shape of the battery, a curved battery of irregular shape is disclosed in published information. In one embodiment, one end of this strip-shape battery is bent into shape; while in another embodiment, both ends of battery are bent into shape. Through this kind of bent shape, the battery can be put into the irregular battery receiving space.

in this respect, presently, the design of the battery is not quite satisfactory, and it has much room for improvement.

### SUMMARY OF THE INVENTION

In view of the problems and limitations of the prior art, the present invention provides a curved battery, to effectively overcome the shortcomings of the prior art.

From the published information it can be known that, one end or both ends of this type of battery is or are bent into shape relative to its middle portion. Therefore, structure-wise, the curvature of the entire battery is irregular. Namely, the curvature of one end or both ends is/are different relative to the middle portion of the battery main body, such that this kind of curved battery provides more design flexibility for diminishing size and irregular shape electronic products.

To advance progress of the Industries and keep pace of innovation of the modern age, the present invention provides a curved battery, that is different from the Prior Art, to solve the shortcomings mentioned above.

A major objective of the present invention is to provide a curved battery, and in particular to a curved battery and a manufacturing method thereof

In order to achieve the objective mentioned above, the present invention provides a curved battery manufacturing method, including the following steps: electrode sheet electroplating, electrode sheet rolling, first sealing, heating, pouring in electrolyte fluid, charging, vacuuming, second sealing, and shaping. Wherein, it is worth to note that, in the step of rolling, the rolling is performed along the long side of the electrode sheet. Also, in the step of first sealing, one side each of the positive electrode and negative electrode is sealed first with one side each of the adjacent side edges. Then, after the step of first sealing, perform the heating step to remove the vapor in the sack sealed along its three sides. Subsequently, pour in the electrolyte fluid into the sack, and seal temporarily the sides of the sack containing the electrolyte fluid, and then perform charging step for the entire electrolyte fluid. Then, remove one of the sealed sides of the charged- and half-finished battery, to perform a vacuuming step. Afterwards, seal that side again. And finally, the sealed and half-finished battery is performed a bending and shaping step, to finish the entire manufacturing process after hot pressing.

In an aspect of the present invention, in the heating step, the heating temperature is 75° C. with a heating duration of 12 hours.

In another aspect of the present invention, the electrolyte fluid is LiPF₆.

In a further aspect of the present invention, in the step of charging, the current intensity is 3.6 mA, for a duration of 6 hours.

In a yet another aspect of the present invention, for the curved battery provided when viewed as a whole, its outer contour forms a curved surface of uniform curvature.

In another aspect of the present invention, the thickness of the curved battery is 2.2 mm.

In a further aspect of the present invention, the electrode sheet of the curved battery is extended along a direction parallel to the long side of the battery main body.

### BRIEF DESCRIPTION OF THE DRAWINGS

The related drawings in connection with the detailed descriptions of the present invention to be made later are described briefly as follows, in which:

FIG. 1 is a flowchart of the steps of a curved battery manufacturing method according to the present invention;

FIG. 2 is a schematic diagram of structure of a curved battery according to the present invention; and

FIG. 3 is a schematic diagram of structure of a curved battery in a roll-up configuration according to the present invention.

### DETAILED DESCRIPTION OF THE PREFERRED EMBODIMENT

The purpose, construction, features, functions and advantages of the present invention can be appreciated and understood more thoroughly through the following detailed description with reference to the attached drawings.

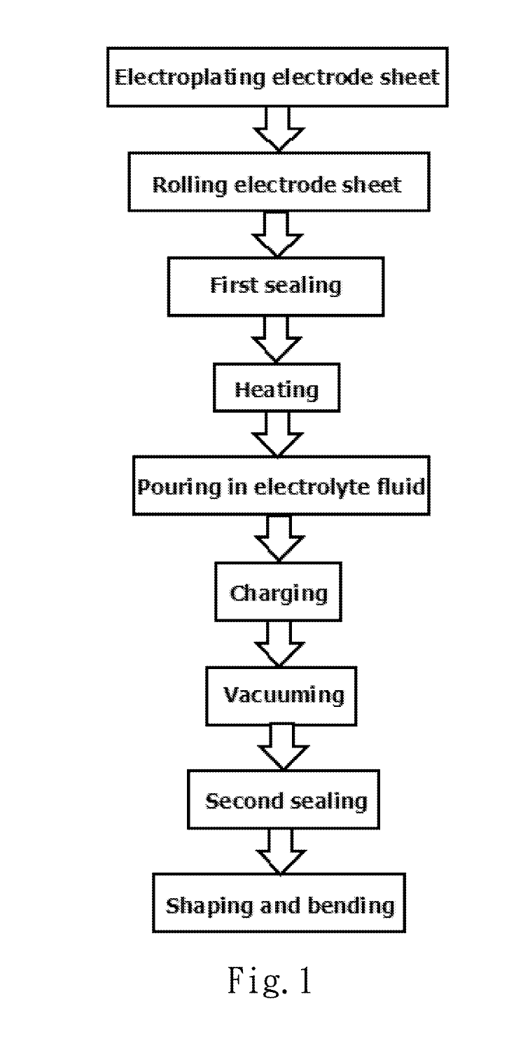

Refer to FIG. 1 for a flowchart of the steps of a curved battery manufacturing method according to the present invention, including the following steps:

### Electroplating the Electrode Sheet

In preparing positive/negative electrodes (namely, anode and cathode), firstly, a strip-shape electrode sheet (conductive sheet) is provided, which has two portions selected respectively as a positive portion and a negative portion. The surface of the positive portion is applied with an anode coating, for example, lithium cobalt oxide coating, to form a positive electrode. The surface of the negative portion is applied with a cathode coating, for example, a graphite coating, to form a negative electrode. Then, a separation film is used to wrap the entire coated electrode sheet, to prevent the contact of the positive electrode and the negative electrode to form short circuit. In an embodiment of the present invention, the positive electrode at its outermost end is welded with a positive tab lead located vertically to the direction of the positive electrode and/or negative electrode. Also, the negative electrode at its outermost end is welded with a negative tab lead located vertically to the direction of the positive electrode and/or negative electrode. The disposition of the positive tab lead and negative tab lead is to facilitate its electrical connection with outside electronic elements upon completion of the finished battery.

### Rolling the Electrode Sheet

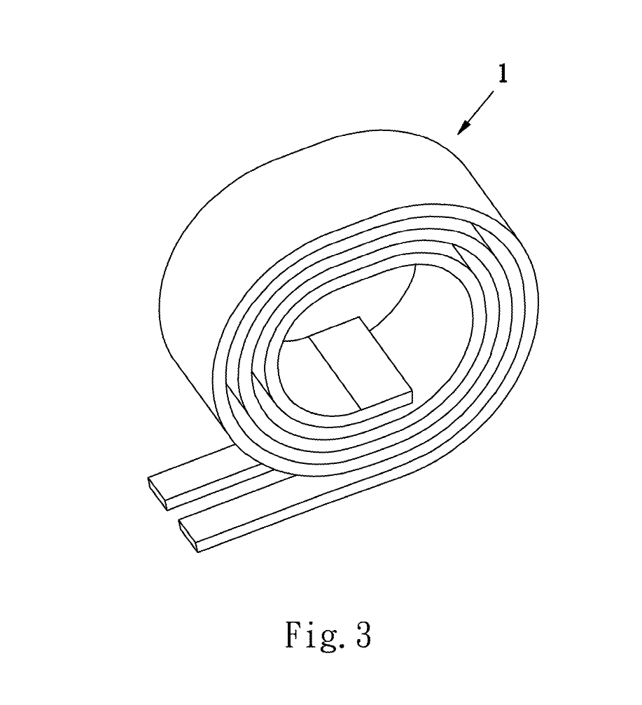

Roll up the wrapped positive/negative electrode sheet along its long side to form a multi-layered hollow roll structure as shown in FIG. 3, that means the positive/negative electrodes sheet is rolled to form separate layers from outside to inside, with the positive tab lead and negative tab lead located at the outer most end, and on the outermost layer.

### First Sealing

For the rolled-up electrode sheets, it basically has three open side edges, namely, a center side edge having positive tab lead and negative tab lead, and the two side edges adjacent to the center side edge. At this time, a suitable machine such as an edge sealing machine can be used to seal the side edge having the positive/negative tab leads, and a side edge adjacent to the side edge. During edge sealing, the edge sealing temperature is around 210˜230° C., with edge sealing duration of 2.5˜3.5 seconds.

### Heating

In the heating step, the heating temperature is 75° C., with its duration of 11˜13 hours, preferably 12 hours. The objective of heating is to remove the water vapor formed in the sack having its three edges sealed through baking

### Pouring in Electrolyte Fluid

In the dried sack, pour in electrolyte fluid containing LiPF₆. In the pouring-in process, the ambient temperature is preferably 25±5° C., with relative humidity less than 2%. After the pouring in step, the open side edge is preferably sealed temporarily, to make the sack to form a completely sealed object.

### Charging

In the charging step, a suitable machine is used to charge the electrolyte fluid in the sack, with the charging parameter of current intensity of 3.6 mA, to charge for 6 hours.

### Vacuuming

Before performing vacuuming, reopen the side edge of the sack for the side edge not having positive tab lead and negative tab lead, to evacuate the excessive gas remaining in the main body by means of negative pressure. The evacuation duration is 5 seconds, to achieve vacuum greater than 90%.

### Second Sealing

Upon finishing vacuuming, seal the open side edge again using the edge sealing machine, to achieve at least 90% vacuum state in the sack.

### Shaping and Bending

In this process, the at least 90% vacuumed sack is put into a banding machine, that is provided with a plurality of rollers capable of pushing the sack to move in a single direction, with a rotation speed of 20˜30 rpm. When the sack going through the roller, the roller bands the sack of long-strip shape into an arc shape having uniform curvature.

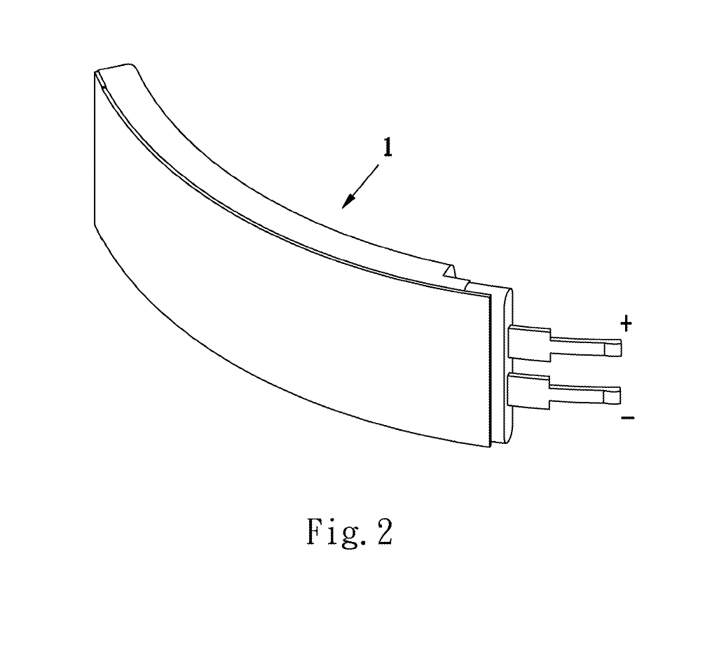

Based on the descriptions mentioned above, and also refer to FIG. 2, it can be known that, the structure of the curved battery shows a long-strip shape having a uniform curvature, and that is not disclosed in the prior art. Also, there is no teaching in the Prior Art to indicate that the battery main body may have a uniform curvature. Further, in the Prior Art, no implicit or explicit suggestions are given to the public to design the curved battery of the present invention. Therefore, the curved battery of the present invention is an innovation, that is not disclosed or anticipated by the Prior Art.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A curved battery manufacturing method, comprising the following steps:
providing a strip-shape electrode sheet, which has two portions selected respectively as a positive portion and a negative portion, wherein a surface of said positive portion is applied with an anode coating, while surface of said negative portion is applied with a cathode coating, then a separation film is used to wrap said entire coated electrode sheet,
rolling said electrode sheet having separation film wrapped around along its long edge, so that a positive tab lead and a negative tab lead at the outermost ends of said electrode sheet, are on the outermost layer of roll body;
after rolling, said rolled electrode sheet is provided with three open side edges, including one side edge having said positive tab lead and said negative tab lead, and two side edges adjacent to said side edges, perform first sealing for said positive tab lead and said negative tab lead;
performing heating for the sack having three side edges sealed;
pouring in electrolyte fluid into the dried sack, and perform charging for said electrolyte fluid;
reopening said sealed side edge not having said positive tab lead and said negative tab lead;
performing vacuuming to remove excessive gas in said sack by means of negative pressure;
performing second sealing for opened side edge; and
bending said long-strip sack into an arc shape of uniform curvature.

2. The curved battery manufacturing method as claimed in claim 1, wherein said anode coating is made of lithium cobalt oxide coating, while the cathode coating is made of graphite.

3. The curved battery manufacturing method as claimed in claim 1, wherein said first sealing is to seal said side edge having said positive tab lead and said negative tab lead, and said adjacent side edge not having said positive tab lead and said negative tab lead.

4. The curved battery manufacturing method as claimed in claim 3, wherein temperature for said first seal is 210˜230° C., with a duration of 2.5 sec˜3.5 sec.

5. The curved battery manufacturing method as claimed in claim 3, wherein temperature for heating said sack having three side edges sealed is 75° C., for a duration of 11˜13 hours.

6. The curved battery manufacturing method as claimed in claim 3, wherein temperature for pouring in electrolyte fluid is 25±5° C.

7. The curved battery manufacturing method as claimed in claim 3, wherein said vacuum is greater than 90%.

8. The curved battery manufacturing method as claimed in claim 3, wherein said positive tab lead and said negative tab lead are extended in a direction parallel to long edge of said electrode sheet.

9. The curved battery manufacturing method as claimed in claim 1, wherein said positive tab lead and said negative tab lead are welded perpendicular to direction of said positive electrode and said negative electrode.

10. A curved battery, provided with a long-strip shape main body, and is characterized in that, said main body has a uniform curvature.

11. The curved battery as claimed in claim 10, wherein said curved battery is provided with a positive tab lead and a negative tab lead, extended in a direction parallel to a long side of said main body.
